(19) United States
(12) Patent Application Publication
(10) Pub. No.: US 2008/0310315 A1
(43) Pub. Date: Dec. 18, 2008

(54) Equalized trigger

(75) Inventor: Frederic Antonin, Ramsey, NJ (US)

Correspondence Address: LECROY CORPORATION, 700 CHESTNUT RIDGE ROAD, CHESTNUT RIDGE, NY, 10977, US

(73) Assignee: LeCroy Corporation, Chestnut Ridge, NY (US)

(21) Appl. No.: 11/820,131

(22) Filed: Jun. 18, 2007

(51) Int. Cl. H04L 1/00

(52) U.S. Cl. 370/248

(57) ABSTRACT

A data acquisition apparatus and method are provided. The apparatus comprises a receiver for receiving an analog data signal, an equalizer for equalizing the received analog data signal. A trigger element is provided for generating a trigger signal in accordance with the equalized analog data signal. A memory element stores a digitized version of the received analog data signal digitized by an analog to digital converter in accordance with the generated trigger signal.

### FIELD OF THE INVENTION

This invention is related generally to triggering an electronic test instrument, and most particularly to a method and apparatus for improving trigger performance and reliability of triggering based upon degraded waveforms by deriving a trigger from an equalized waveform.

### BACKGROUND OF THE INVENTION

Transmission of information over a link or network often may degrade the quality of the signal. When utilizing such a signal at the receiving end of such a link, problems may arise. In one particular scenario, if a user is attempting to trigger a test and measurement or other device on the degraded signal, the trigger may be unstable or missing. This degradation of the signal may be a result of losses on the cables during transmission, or losses from a PC board connection traces between a transmitter and a receiver.

Regardless of the reasons for degradation, it is very difficult to generate a reliable trigger based upon this degraded signal. Indeed, an eye diagram representation of such a signal may present a substantially closed eye, where there may be no opening present. At this point, deciding on when to trigger may be impossible.

This problem may be exacerbated by the fact that many receiving devices include equalization systems so that the users of the finally received and output signal may not be aware of the degradation prior to equalization. In this case, the user may not be interested in the appearance of the signal at the input to the receiver, but rather at the output to the equalizing stage. However, it is possible that this location is buried inside a received chip and cannot be probed.

Therefore it would be beneficial to provide an improved apparatus that overcomes the drawbacks of the prior art.

Still other objects and advantages of the invention will in part be obvious and will in part be apparent from the specification and the drawings.

### SUMMARY OF THE INVENTION

Therefore, in accordance with the invention, a method and apparatus for use with a test and measurement apparatus is provided including an equalizer circuit adapted to implement a transfer function to undue any effects caused by the travel of a signal through a cable, PCB, or other structure. As the effects associated with the travel of a signal through a transmission path increase with an increased frequency of the signal, this problem may be even more acute for higher frequency signals. In accordance with the invention, such an equalizer circuit is placed between a front end amplifier and a trigger circuit of the test and measurement apparatus. The signal integrity is improved before the trigger signal is derived, and therefore the trigger circuit can make a better decision regarding when and whether to generate a trigger.

While attempts in the past have been made to solve this problem using an “external solution” comprising an equalizer module external to the test and measurement equipment, this external solution poses at least two significant problems. First the input sensitivity of such an external module would typically be limited. However, in accordance with the invention, because the module is placed after the front end of the test and measurement apparatus after a normalized amplitude of the signal is present, this problem is overcome.

Second, use of such an external equalizer requires probing by the test and measurement apparatus in two locations, once before the module to view the original signal and once after the module to provide the equalized signal on which to base the trigger signal, thus using two channels for the process. On an apparatus such as a four channel digital oscilloscope, this procedure reduces the available input channels in half. By employing the processing and apparatus in accordance with the invention, this dual probing issue is avoided. Each single input channel can be used independently, thus avoiding reduction in the capabilities of the test and measurement apparatus, such as a digital oscilloscope.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a more complete understanding of the invention, reference is made to the following description and accompanying drawings, in which:

FIG. 1A depicts a simulated eye diagram derived from an unequalized binary signal in accordance with an embodiment of the invention;

FIG. 1B depicts a simulated eye diagram derived from an equalized binary signal in accordance with the embodiment of the invention.

FIG. 2 illustrates the generation and output of an eye diagram;

FIG. 3 depicts a block diagram of a digital storage oscilloscope including the equalization hardware in accordance with an embodiment of the invention;

FIG. 4 depicts a block diagram of a digital storage oscilloscope including the equalization hardware in accordance with a second embodiment of the invention; and

FIG. 5 depicts an unequalized and an equalized waveform in accordance with the invention.

### DETAILED DESCRIPTION OF THE PREFERRED EMBODIMENTS

In accordance with the present invention, a method and apparatus are provided to improve trigger capability and reliability by adding an equalizer circuit in a trigger signal path of a test and measurement apparatus, for example in a digital storage oscilloscope (DSO). The equalizer may restore a received signal that has been degraded due to transmission media losses, skin effect or any other frequency dependent attenuation on the signal path. This restored signal may then be used to generate an accurate trigger signal.

In particular, when used with a DSO, an equalizer may be placed between an input amplifier and a trigger decision circuit. More particularly, the equalizer may be placed in front of a CDR (clock and data recovery) circuit in order to improve the capability of the CDR if this CDR is inside the oscilloscope or is part of an oscilloscope accessory (e.g. a probe). In accordance with the invention, the setup also may allow the equalizer to be bypassed, or may allow equalization value to be appropriately set so that the signal is passed around or through the equalizer without performing any processing on the signal (i.e. without being equalized).

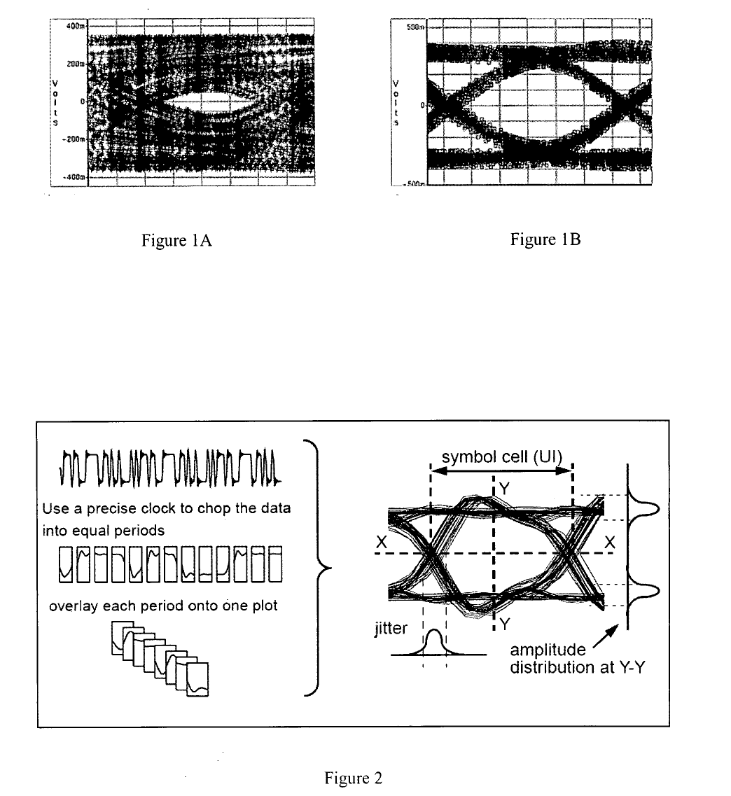

Referring first to FIGS. 1A and 1B, FIG. 1A depicts a signal received by a test and measurement device before equalization. The image shows a conventional and well known in the art eye diagram. As is evident from this eye diagram, the eye is not well defined and the traces are drawn over nearly the entire display area, indicating a substantially degraded signal. This image may be indicative of a signal received by a test and measurement apparatus receiving a signal through a transmission line, PCB or other medium that may greatly attenuate or otherwise affect the signal.

Next, referring to FIG. 1B, this figure depicts the same signal after passing through an equalizer, such as that proposed in accordance with the present invention. As is clear, the eye diagram has been substantially cleaned up. The eye is open, the traces generally overlap, and most importantly, this is indicative that the signal has a consistent timing relative to the actually transmitted signal. Thus, even if a user may wish to view the signal shown in FIG. 1A, using the signal shown in FIG. 1B, in accordance with the invention, may provide a far more accurate and repeatable trigger timing.

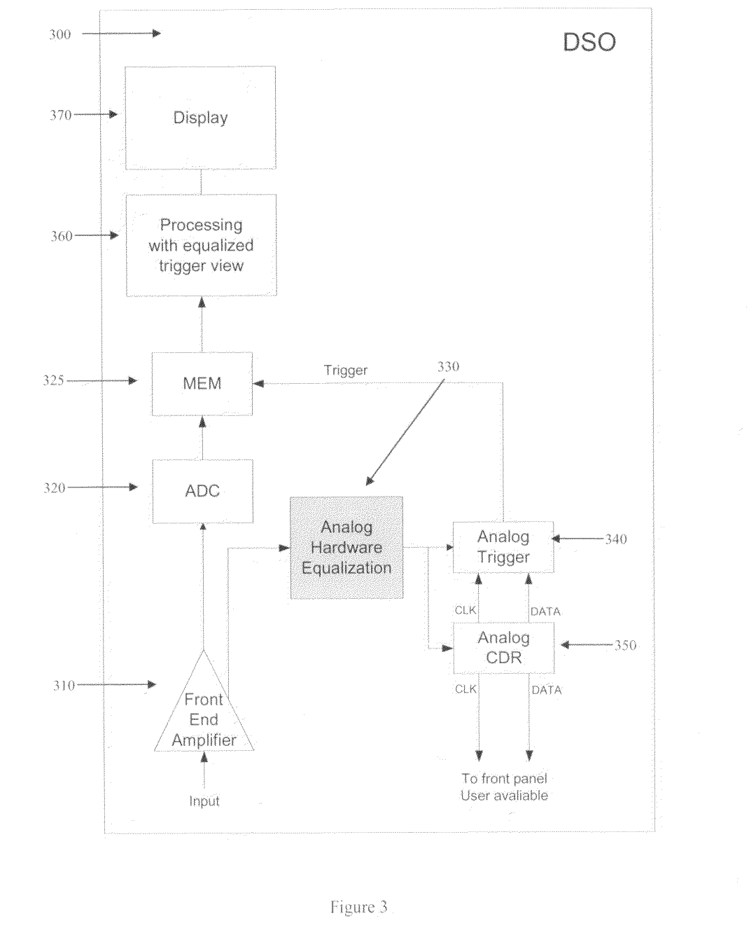

Referring next to FIG. 2, a short description of the formation of an eye diagram, and why the application of the present invention will improve results will be provided. As is shown in FIG. 2, an eye diagram is generated by using a precise clock to chop up a data signal into bit periods, and then overlaying the signal from each of these periods onto a single display. If the signal were perfectly repetitive in both the amplitude and timing direction, and if the trigger for slicing the signal were precisely accurate, the traces would all overlay in a single line and there would be no spread in the eye diagram. However, as is shown in FIG. 2 jitter may result from amplitude discrepancies or timing discrepancies. Using a distorted signal to trigger for acquiring a waveform may decrease trigger reliability, accuracy and jitter.

Referring next to FIG. 3, a proposed DSO 300 constructed in accordance with the present invention is shown. The invention may also be applicable to other signal processing apparatuses as appropriate. An input signal is first provided to a front end amplifier 310, and amplified to a desired level thereby. As in a conventional test and measurement apparatus or other data processing device, this signal is then forwarded to an analog to digital converter (ADC) for digitization and a memory element for storage. Memory 325 utilizes a trigger signal to know when to properly acquire and store the digitized input signal. Thus, in accordance with an embodiment of the invention, the input and amplified signal may also be provided from front end amplifier 310 to an analog hardware equalizer 330. Equalization processing takes place in a known manner, particularly compensating for disturbances in the transmission path, or other anomalies that may have affected the signal during its transmission to DSO 300. The analog equalizer may comprise any known type, including passive, active, single tap, multi-tap, fixed, adaptive, or any other appropriate equalizer. Additionally, it is possible to equalize the signal before the front end amplifier, although the inventor of the present invention has determined that less favorable results may be obtained.

The equalized signal may then be provided to a trigger circuit 340 for generating an analog trigger signal. The analog CDR circuit 350 in turn may output the equalized data signal and corresponding recovered clock be utilized by trigger 340. Trigger circuit 340 may generate a trigger signal based upon the received equalized input signal, and may forward the trigger signal to the memory 325 for use in triggering when storing the amplified input signal.

In accordance with an alternative embodiment of the invention, a digital pattern trigger and clock data recovery (CDR) circuitry may be employed, thus allowing for triggering on various digital signal elements, such as a digital pattern, pulse width, pulse time, or any other characteristic of a digital signal that a user may want to rely on as the basis for timing a trigger. Referring once again to FIG. 3, such a digital implementation preferably also forwards the equalized digital signal form equalizer 330 to a CDR 350. In turn a clock recovered from this digital signal, as well as the digital signal is forwarded to trigger element 340. In addition a second copy of the recovered clock and data may be provided to the user from CDR 350 via a front panel of the instrument, or the like.

Whether a trigger based upon an analog signal, or a trigger based upon a digital signal is used, the input signal is digitized by ADC 320, and stored to memory 325 in accordance with the trigger generated by trigger element 340, as noted above.

After digitizing and storing, various processing of the digital signal may be performed by processing hardware and/or software 360, and finally, the resulting processed information may be displayed in a display 370. Thus, in accordance with the invention, an equalized signal is used to generate a trigger signal for digitizing data using an ADC, and/or also for recovering a clock therefrom.

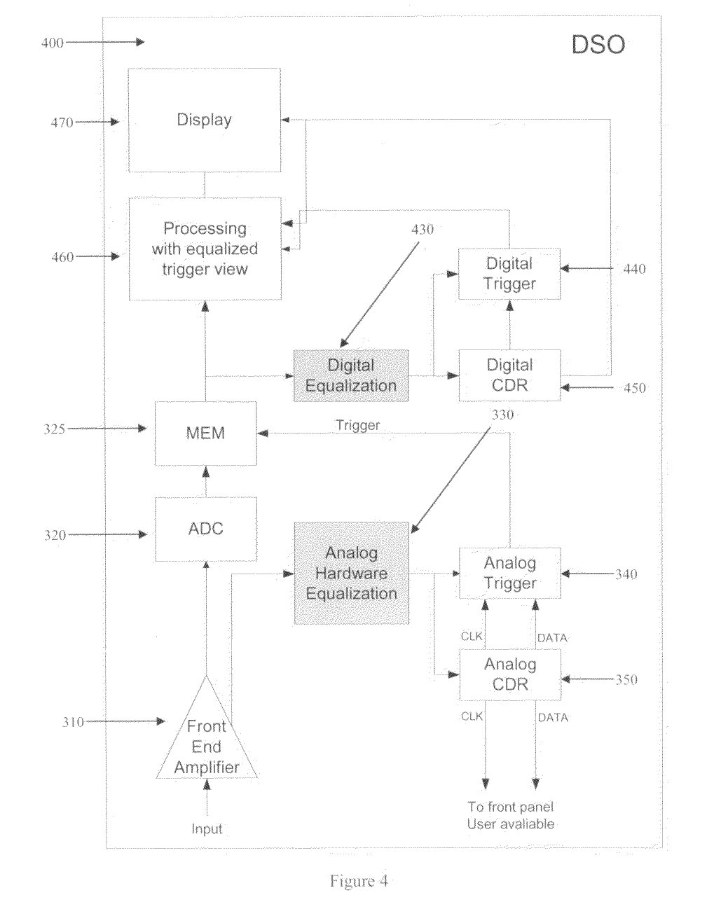

Referring next to FIG. 4, a digital equalization portion is added to DSO 300 of FIG. 3. While this digital equalization portion is shown in conjunction with the analog equalization portion of FIG. 3, either equalization portion may be implemented independently. In FIG. 4, like elements to those in FIG. 3 carry like reference numbers.

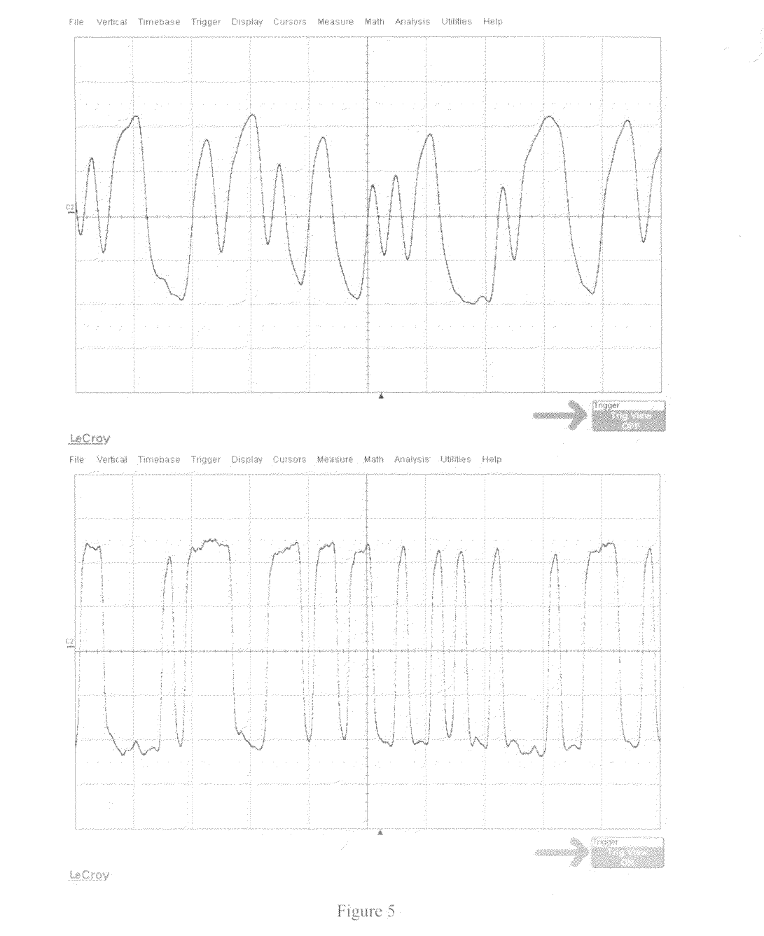

A DSO 400 performs processing similar to that of DSO 300 through the storing of the digitized input signal at 325. Thereafter, as in DSO 300, this digital signal may be forwarded to one or more processing hardware and/or software processing elements 460. The digital signal may also be forwarded to a digital equalizer 430. Equalization of the digital signal may be performed to mimic the effect of the analog equalization as described below, therefore acting as a trigger view (see FIG. 5) or to emulate a user defined equalizer that may be desired to be added virtually to the signal path. An equalized digital signal may then be output from digital equalizer 430 to a digital trigger circuit 440 and/or to a digital CDR circuit 450.

The digital CDR circuit 450 in turn may output the recovered clock to display 470 to properly clock data, to processor 360, and to digital trigger 440. The digital trigger 440 may generate a trigger signal based upon the received equalized digital signal and the recovered clock received from digital CDR 450, and may forward the trigger signal to processing element 460 for use in triggering when digitizing the amplified input signal. Processor element 460 may utilize the recovered clock, data and trigger signal to properly process the digital data signal read from MEM 325. After processing, the processed data is forwarded to display 470, which may use the recovered clock from digital CDR 450 to properly display the processed digital data thereon.

Referring finally to FIG. 5, a comparison showing the display of acquired data on a display with the processing in accordance with this invention first disabled, and then implemented is shown. In the first upper panel, the processing of the invention is disabled, while in the second, lower panel, the processing of the invention is enabled. As can be seen, in the lower panel the signal is more precise, amplitudes of the waveform segments are consistent, and rise times are more precise. As a comparison, the upper panel shows inconsistent amplitudes for the waveform segments, far longer and inconsistent rise times, and general imprecision in the signal.

Therefore, in accordance with the invention, an equalizer may be used to equalize a signal before processing the signal to recover a clock thereform, and/or generate a trigger therefrom. The equalizer may be used in an analog, digital, or both portions of a data acquisition device, such as a test and measurement apparatus, including an oscilloscope.

While the invention has been described applicable to an oscilloscope, the invention is intended to be equally applicable to other test and measurement apparatuses and to electronic apparatuses in general. Indeed, any application in which a user desires to acquire an analog or digital signal may incorporate the invention. Thus, implementation of only the digital portion of the invention may be applied to a protocol analyzer, or other digital acquisition device. For example, a digital signal may be received by a receiver in place of the digital signal being generated by ADC 320 in FIG. 4. Thereafter, processing may proceed as noted with respect to elements 430, 440, 450, 460 and 470 of FIG. 4.

It will thus be seen that the objects set forth above, among those made apparent from the preceding description, are efficiently attained and, since certain changes may be made in the above construction(s) without departing from the spirit and scope of the invention, it is intended that all matter contained in the above description or shown in the accompanying drawing(s) shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A data acquisition apparatus, comprising:
a receiver for receiving an analog data signal;
an equalizer for equalizing the received analog data signal; and
a trigger element for generating a trigger signal in accordance with the equalized analog data signal;
whereby a memory element stores a digitized version of the received analog data signal digitized by an analog to digital converter in accordance with the generated trigger signal.

2. The data acquisition apparatus of claim 1, wherein the receiver comprises a front end amplifier.

3. The data acquisition apparatus of claim 1, wherein the data acquisition apparatus comprises a test and measurement apparatus.

4. The data acquisition apparatus of claim 3, wherein the test and measurement apparatus comprises an oscilloscope.

5. The data acquisition apparatus of claim 1, further comprising a processing element for performing further processing on the digitized signal.

6. The data acquisition apparatus of claim 5, further comprising a display for displaying the processed digital data.

7. The data acquisition apparatus of claim 1, further comprising:
a digital equalizer for equalizing the digitized signal;
a digital clock data recovery element for recovering a digital clock from the equalized digitized signal; and
a digital trigger for generating a digital trigger signal in accordance with the recovered digital clock and the digitized signal;
whereby the recovered digital clock and digital trigger signal are used by a processing element to perform additional processing on the digitized signal.

8. The data acquisition apparatus of claim 5, further comprising a display for displaying the processed digital signal in accordance with the recovered digital clock signal.

9. A data acquisition apparatus, comprising:
a receiver for receiving an analog data signal;
an equalizer for equalizing the received analog data signal;
a clock data recovery element for recovering a clock signal from a digital representation of the equalized analog signal; and
a trigger element for generating a trigger signal in accordance with the recovered clock and the digital representation of the equalized analog signal;
whereby a memory element stores a digitized version of the received analog data signal digitized by an analog to digital converter in accordance with the generated trigger signal.

10. A data acquisition apparatus, comprising:
a receiver for receiving a digitized signal;
a digital equalizer for equalizing the digitized signal;
a digital clock data recovery element for recovering a digital clock from the equalized digitized signal; and
a digital trigger element for generating a digital trigger signal in accordance with the recovered digital clock and the digitized signal;
whereby the recovered digital clock and digital trigger signal are used by a processing element to perform additional processing on the digitized signal.

11. The data acquisition apparatus of claim 10, further comprising a display for displaying the processed digital signal in accordance with the recovered digital clock signal.

12. A method for acquiring data, comprising the steps of:
receiving an analog data signal;
equalizing the received analog data signal;
generating a trigger signal in accordance with the equalized analog data signal;
storing a digitized version of the received analog data signal in accordance with the generated trigger signal.

13. The method of claim 12, further comprising the step of performing further processing on the digitized signal.

14. The method of claim 13, further comprising the step of displaying the processed digital data.

15. The method of claim 12, further comprising the steps of:
equalizing the digitized signal;
recovering a digital clock from the equalized digitized signal;
generating a digital trigger signal in accordance with the recovered digital clock and the digitized signal; and
performing additional processing on the digitized signal in accordance with the recovered digital clock and digital trigger signal.

16. The method of claim 15, further comprising the step of displaying the processed digital signal in accordance with the recovered digital clock signal.

17. A method for acquiring data, comprising the steps of:
receiving an analog data signal;
equalizing the received analog data signal;
recovering a clock signal from a digital representation of the equalized analog signal;
generating a trigger signal in accordance with the recovered clock and the digital representation of the equalized analog signal; and
storing a digitized version of the received analog data signal in accordance with the generated trigger signal.

18. A data acquisition method, comprising the steps of:
receiving a digital signal;
equalizing the digital signal;
recovering a digital clock from the equalized digitized signal;
generating a digital trigger signal in accordance with the recovered digital clock and the digitized signal; and
performing additional processing on the digitized signal in accordance with the recovered digital clock and digital trigger signal.

19. The method of claim 18, further comprising the step of displaying the processed digital signal in accordance with the recovered digital clock signal.
